(19) United States
(12) Patent Application Publication
(10) Pub. No.: US 2007/0024914 A1
(43) Pub. Date: Feb. 1, 2007

(54) Screen designing method and screen designing device providing a reduction of moire pattern

(75) Inventors: Woo-Jun Chung, Suwon-si (KR); Choon-Woo Kim, Incheon Metropolitan City (KR); Byong-Min Kang, Incheon Metropolitan City (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/488,646

(22) Filed: Jul. 19, 2006

(30) Foreign Application Priority Data
Jul. 27, 2005 (KR) 2005-68619

(51) Int. Cl. H04N 1/409

(52) U.S. Cl. 358/3.26

(57) ABSTRACT

A screen designing method and a screen designing device for reducing a moire pattern are provided. In the screen designing method, screen parameters corresponding to a preset screen frequency, a preset screen angle, and a preset resolution are detected first. Then, the coordinates of dot centers being the centers of cluster dots each with a plurality of microdots are detected. Next, a dot center order indicating a sequence in which the dot centers are turned on is determined. Thereafter, a microdot order indicating a sequence in which the microdots are turned on is determined using an evaluation function that quantitates the perception of a moiré pattern by a human's vision. Accordingly, the microdot order is determined using the evaluation function based on the visual characteristics of a human, thereby preventing patterns that degrade the quality of image formation and a moiré pattern from being generated.

### CROSS-REFERENCE TO RELATED PATENT APPLICATIONS

This application claims the benefit under 35 U.S.C. §119(a) of Korean Patent Application No. 10-2005-0068619, filed on Jul. 27, 2005, in the Korean Intellectual Property Office, the entire disclosure of which is hereby incorporated by reference.

### BACKGROUND OF THE INVENTION

1. Field of the Invention

The present invention relates to image formation. More particularly, the present invention relates to a screen designing method and a screen designing device for reducing a moiré pattern, by which a continuous tone image is transformed into a binary image using a screening technique.

2. Description of the Related Art

The difference between an imaging device with multiple levels and an image forming device is that the image forming device generally has two binary levels depending on the output or non-output of a dot. A method of printing a multi-level input image using two binary levels is referred to as halftoning. Examples of the halftoning technique include error diffusion and screening, among others.

Error diffusion is a method of diffusing an error resulting from the binarization of a current pixel to neighboring pixels to be binarized by a predefined kernel value at a certain rate. Screening is a method of performing binarization using a comparison between a gray level of a pixel to be binarized and a predetermined screen (an array of threshold values). Error diffusion provides faster image formation than screening but produces an image of lower quality at a low resolution than screening. Error diffusion is not suitable for laser printers in which locations and sizes of dots are not constant. Hence, screening is widely used in laser printers.

Screens are classified into amplitude modulated (AM) screens and frequency modulated (FM) screens according to a method of arranging dots. Since AM screens output dots on a cluster-by-cluster basis, they output dots more stably than FM screens. Therefore, most laser printers use AM screens. AM screens are classified into AM ordered screens and AM stochastic screens according to a configuration of cluster dots. AM ordered screens have periodic configurations of cluster dots. AM stochastic screens have non-periodic configurations of cluster dots.

Examples of terms used in AM ordered screens include a microdot, a cluster dot, a dot center, an order, a screen frequency (lpi), and a screen angle, among others. The microdot denotes a pixel, which is a unit in which an image is formed. The cluster dot denotes a dot pattern that is made up of several microdots. The dot center denotes a microdot corresponding to the center of a cluster dot. The order denotes a sequence in which microdots are turned on, the screen frequency denotes the number of cluster dots per unit length, and the screen angle denotes an angle by which an array of cluster dots is rotated.

When a screen frequency, a screen angle, and a resolution are set, screen parameters and the coordinates of dot centers are calculated according to a representative method of AM ordered screen design. The screen parameters are used to calculate the size of a screen with the set screen frequency and the set screen angle. After the coordinates of the dot centers are calculated, an order in which the dot centers are turned on is determined. Thereafter, microdots around the dot centers are grown according to the order. Microdot growth is achieved by ordering microdots with minimal values determined according to a spot function. Generally, a spot function uses a distance between a dot center and a dot around the dot center.

In the AM ordered screen designing method, an integer coordinate is used as the coordinate of a dot center, so that a moiré pattern is detected. To remove the moiré pattern, several candidate integer coordinates close to the real number locations of dot centers are set as the coordinates of the dot centers and randomly distributed. Although the AM ordered screen designing method reduces the moiré pattern by distributing the locations of dot centers, a problem of outputting a low quality image in a shadow range still exists.

Accordingly, there is a need for an improved system and method for providing a high quality image by reducing a moiré pattern.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a screen designing method and a screen designing device for reducing a moiré pattern, in which an order in which microdots are turned on is determined using an evaluation function based on the visual characteristics of a human.

According to an aspect of an exemplary embodiment of the present invention, a screen designing method is provided to reduce a moiré pattern. Screen parameters corresponding to a preset screen frequency, a preset screen angle, and a preset resolution are detected. The coordinates of dot centers are detected as the centers of cluster dots each with a plurality of microdots. A dot center order is determined to indicate a sequence in which the dot centers are turned on. A microdot order is determined to indicate a sequence in which the microdots are turned on by using an evaluation function that quantitates the perception of a moiré pattern by a human's vision.

According to another aspect of an exemplary embodiment of the present invention, a screen designing device is provided. The device includes a parameter detection unit, a dot center coordinate detection unit, a dot center order determination unit, and a microdot order determination unit. The parameter detection unit detects screen parameters corresponding to a preset screen frequency, a preset screen angle, and a preset resolution. The dot center coordinate detection unit detects the coordinates of dot centers which are the centers of cluster dots each with a plurality of microdots. The dot center order determination unit determines a dot center order indicating a sequence in which the dot centers are turned on and the microdot order determination unit determines a microdot order indicating a sequence in which the microdots are turned on, by using an evaluation function that quantitates the perception of a moiré pattern by the human's vision.

Other objects, advantages, and salient features of the invention will become apparent to those skilled in the art from the following detailed description, which, taken in conjunction with the annexed drawings, disclose exemplary embodiments of the invention.

### BRIEF DESCRIPTION OF THE DRAWINGS

The above and other exemplary objects, features, and advantages of certain exemplary embodiments of the present invention will be more apparent from the following description taken in conjunction with the accompanying drawings in which:

FIG. 1 is a flowchart illustrating a screen designing method for reducing a moiré pattern, according to an exemplary embodiment of the present invention;

FIG. 2 is a flowchart illustrating operation 16 shown in FIG. 1;

FIG. 3 illustrates a cluster radius from a dot center according to an exemplary embodiment of the present invention;

FIGS. 4A and 4B illustrate a binary image obtained by binarizing an image with a single gray level using a screen on which a dot center has an integer coordinate and a binary image obtained using a screen on which a dot center has a real number coordinate, respectively according to an exemplary embodiment of the present invention;

FIGS. 5A, 5B, 5C, and 5D illustrate binary images obtained by using irrational tangent screens;

FIGS. 6A and 6B illustrate an image obtained by binarizing an image with a single gray level using a screen and an image obtained by transforming the binary image into an image in the frequency domain, respectively according to an exemplary embodiment of the present invention;

FIG. 7 illustrates images in which an evaluation function for a binary image is expressed according to an exemplary embodiment of the present invention;

FIG. 8 is a graph illustrating changes of evaluation functions for screens designed using a conventional screen designing method and using a screen designing method according to an exemplary embodiment of the present invention;

FIGS. 9A, 9B, and 9C illustrate images obtained by binarizing an image with a single gray level using the three screens of FIG. 8;

FIG. 10 is a block diagram of a screen designing device that reduces a moiré pattern, according to an exemplary embodiment of the present invention; and

FIG. 11 is a block diagram of a microdot order determination unit shown in FIG. 10.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

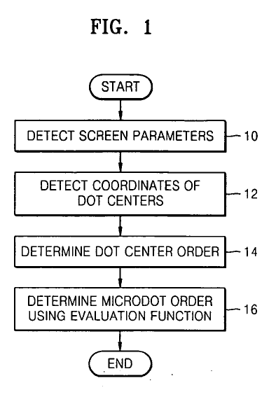

FIG. 1 is a flowchart illustrating a screen designing method for reducing a moiré pattern, according to an exemplary embodiment of the present invention. First, in operation 10, screen parameters corresponding to a preset screen frequency, a preset screen angle, and a preset resolution are detected.

Equation 1 for the screen parameters is:
α=arctan(A/B) (1)
wherein α denotes the preset screen angle, and A and B denote screen parameters to be obtained.

The screen parameters A and B are calculated using Equation 1.

Screen parameters A and B are integers and can be obtained using the following coding method:

“Do until “arctan(A/B)” approximates “input screen angle” sufficiently close {For A=1:Max B=round(A/tan(input screen angle))}”

For example, when a user inputs 56.3° as a screen angle, the screen angle is reset to 56.30993247°, which is the closest to the input angle, and the integer screen parameters A and B are 3 and 2.

The screen parameters are used to calculate the size of a screen with the preset screen frequency and the preset screen angle. The screen size can be calculated using Equation 2:
f=(R\sqrt{A²+B²})/TS (2)
wherein f denotes the preset screen frequency, R denotes the preset resolution, and TS denotes the length of one side of the screen.

After operation 10, coordinates of the dot centers of cluster dots are detected in operation 12. The coordinates of the dot centers of the cluster dots each include a plurality of microdots. The detected coordinates of the dot centers are real number coordinates.

The dot center coordinates are obtained using Equation 3:
Xᵢ₊₁=i×P×cos (α)×R
Yᵢ₊₁=i×P×sin (α)×R, For i=0:N−1 (3)
wherein Xᵢ₊₁ and Yᵢ₊₁ denote a horizontal coordinate and a vertical coordinate, respectively, of an i-th dot center. P denotes the reciprocal of the preset screen frequency, such as a screen period, α denotes the preset screen angle, and R denotes the preset resolution.

After operation 12, a dot center order indicating the sequence in which the dot centers are turned on is determined in operation 14. A dot center farthest from a dot center as a reference is determined sequentially as the dot center order.

After operation 14, a microdot order indicating a sequence in which the microdots are turned on is determined using an evaluation function that quantitates the perception of a moiré pattern by the human's vision in operation 16.

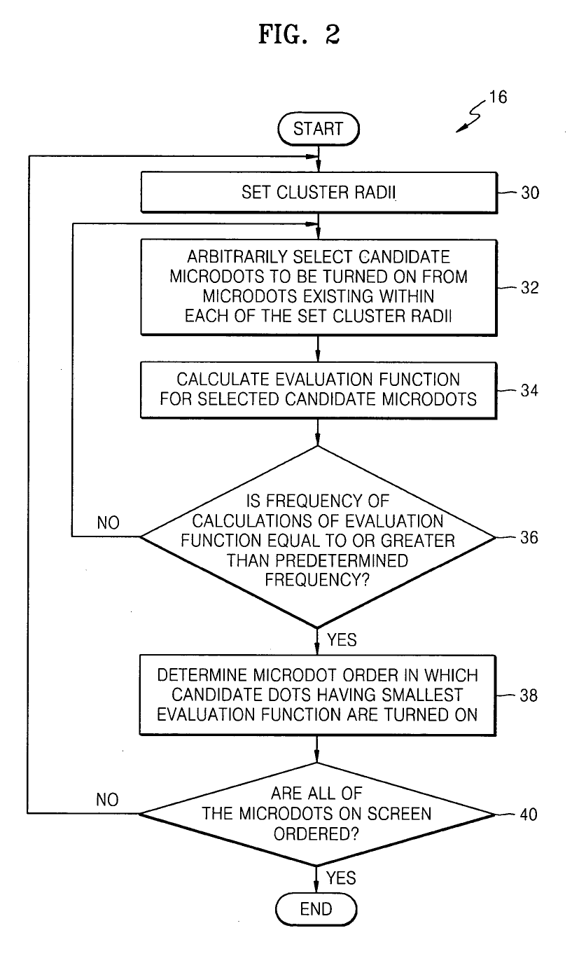

FIG. 2 is a flowchart illustrating operation 16 in greater detail. First, in operation 30, cluster radii extending from the dot centers are set. A cluster radius denotes a range of microdots around a dot center, which are to be candidates of the microdot order.

The cluster radius CR is calculated using Equation 4:
CR=k\sqrt{n/π} (4)
wherein k denotes a constant, n denotes the number of microdots, and π denotes the ratio of the circumference of a circle to its diameter.

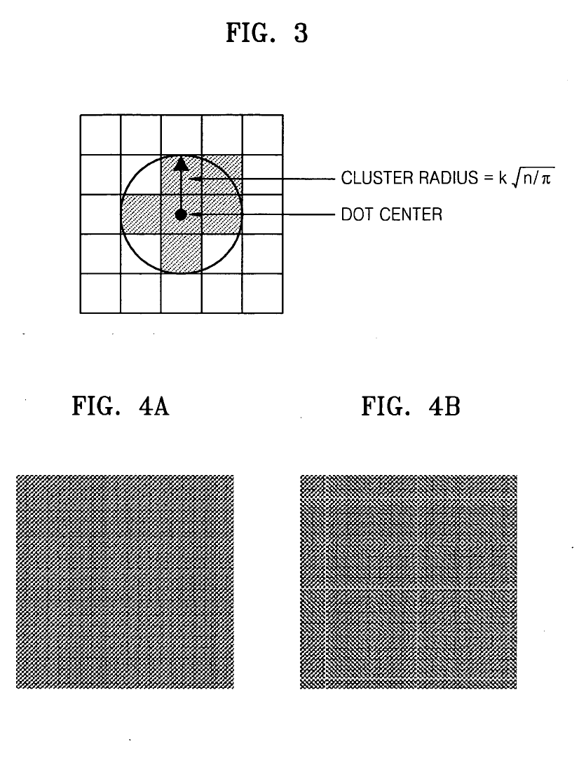

FIG. 3 illustrates a cluster radius extending from a dot center. As illustrated in FIG. 3, the cluster radii extending from the dot centers can be calculated using Equation 4.

Referring back to FIG. 2, after operation 30, a predetermined number of candidate microdots to be turned on are arbitrarily selected from the microdots existing within each of the cluster radii extending from the dot centers in operation 32. In other words, the candidate microdots to be turned on are selected randomly and not according to a particular rule.

After operation 32, an evaluation function for the selected candidate microdots is calculated in operation 34.

The evaluation function is used as a tool to quantitate a moiré pattern. To quantitate a moiré pattern, the characteristics of the moiré pattern should first be checked through two experiments.

FIGS. 4A and 4B illustrate a binary image obtained by binarizing an image with a single gray level using a screen on which a dot center has an integer coordinate and a binary image obtained using a screen on which a dot center has a real number coordinate, respectively. In the case of FIG. 4B, a moiré pattern appears. When a dot center has an integer coordinate, no moiré patterns are generated. The screen used in FIG. 4A is referred to as a rational tangent screen. However, it is difficult to design a rational tangent screen with preferred characteristics, because a screen frequency and a screen angle are preset. The screen used in FIG. 4B is referred to as an irrational tangent screen.

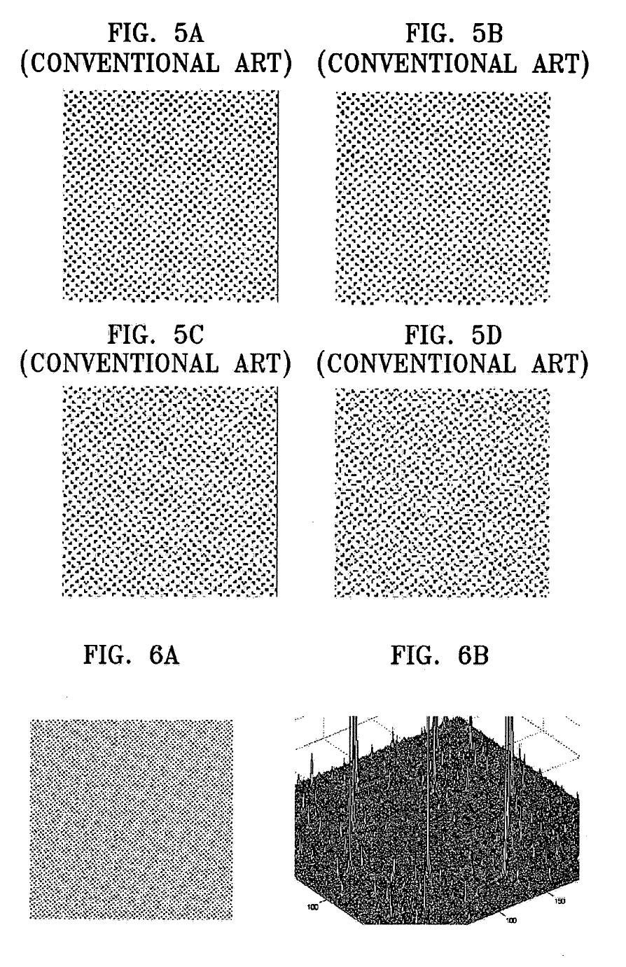

FIGS. 5A, 5B, 5C, and 5D illustrate binary images obtained by using irrational tangent screens. The irrational tangent screens used in FIGS. 5A through 5D have identical screen frequencies, identical screen angles, and identical dot center orders. The dot centers of the irrational tangent screens of FIGS. 5A through 5D are the same. FIG. 5A illustrates a conventional case where microdots which are the closest to a dot center are turned on in the same order as the dot center order. FIG. 5B illustrates a conventional case where microdots which are the closest to a dot center are turned on in an order different from the dot center order. FIG. 5C illustrates a conventional case where microdots are randomly selected from the microdots existing within a certain radius around a dot center and turned on in the same order as the dot center order. FIG. 5D illustrates a conventional case where microdots are randomly selected from the microdots existing within a certain radius around a dot center and turned on in an order different from the dot center order.

Referring to FIGS. 5A, 5B, 5C, and 5D, moiré patterns illustrated in FIGS. 5C and 5D are weaker than moiré patterns illustrated in FIGS. 5A and 5B. In FIG. 5D, microdots are turned on in an order determined by using an evaluation function to reduce a moiré pattern. However, in FIGS. 5C and 5D, an output image is disordered even though moiré patterns are weak. This is because the order in which microdots are turned on is too random. In an exemplary embodiment of the present invention, the order in which microdots are turned on is determined by using an evaluation function to reduce moiré patterns and to reduce the output of a disordered image.

FIGS. 6A and 6B illustrate a binary image obtained by binarizing an image with a single gray level using a screen and an image obtained by transforming the binary image into an image in the frequency domain, respectively. More specifically, FIG. 6A illustrates a binary image obtained by binarizing an image with a single gray level of 204 using a screen with a screen frequency of 150 lpi and a screen angle of 40°. FIG. 6B illustrates an image obtained by frequency conversion on the binary image of FIG. 6A. As illustrated in FIG. 6B, a low-frequency component exists in the image. The low-frequency component is represented as a moiré pattern shown in FIG. 6A. A moiré pattern with a low-frequency characteristic can be seen in FIGS. 6A and 6B.

A frequency distribution C of a low-frequency domain for quantitating the moiré pattern can be calculated using Equation 5:

$$C = {\sum }_{u}^{N} {\sum }_{v}^{N} {MTF ( u , v )}^{2} ( X ( u , v ) \times {X}^{*} ( u , v ) ) \qquad ( 5 )$$

wherein MTF denotes a modulation transfer function for representing the visual characteristics of a human as a frequency domain. X(u, v) denotes a complex number value of an image in a frequency domain and X*(u, v) denotes a conjugate complex number of X(u, v). X(u, v)×X*(u, v) denotes a power spectrum of a binary image.

The MTF is used to apply a weight value to the low-frequency domain. The MFT is expressed as Equation 6:

$${MTF}_{uv} = \{ \begin{matrix}a ( b + c {\tilde{f}}_{uv} ) exp ( - {( c {\tilde{f}}_{uv} )}^{d} ) , & if {\tilde{f}}_{uv} > {f}_{max} \\ 1.0 & otherwise\end{matrix} \qquad ( 6 )$$

wherein ^{\tilde{f}}^{ᵤᵥ} denotes a radial spatial frequency and ^{f}^{ₘₐₓ} denotes a maximum frequency on the radial spatial frequency depending on a direction. Constant numbers are denoted by a, b, c, and d, that is, a=2.2, b=0.192, c=0.114, and d=1.1. The frequency distribution C of the lower-frequency domain is multiplied by a band rejection filter to obtain a formula corresponding to an evaluation function.

As the frequency component of a specific pattern becomes a low frequency and then becomes a large frequency distribution C, the specific pattern is more easily perceived by the human's vision. Since a low frequency component is perceived more easily than a high frequency component, the low frequency component has a large frequency distribution C. In a conventional FM screen designing method, an MTF is used so that a screen may have high-frequency characteristics. However, when an exemplary embodiment of the present invention uses the MTF, a difference between frequency distributions C of a low frequency domain of moiré patterns of different degrees cannot be perceived because a screen frequency belongs to an MTF area. The difference in the frequency distribution C cannot be perceived because a screen frequency is much greater than the frequency of a moiré pattern in the MTF area. Therefore, to prevent the screen frequency from being involved in the calculation of the frequency distribution C of the low-frequency domain, an evaluation function (EF) is calculated using Equation 7:

$$EF = {\sum }_{u}^{N} {\sum }_{v}^{N} {MTF ( u , v )}^{2} ( X ( u , v ) \times {X}^{*} ( u , v ) ) BandR ( u , v ) \qquad ( 7 )$$

wherein MTF denotes a modulation transfer function for representing the visual characteristics of a human as a frequency domain, X(u, v) denotes a complex number value of an image in a frequency domain, X*(u, v) denotes a conjugate complex number of X(u, v), and BandR(u, v) denotes a band rejection filter for removing a screen frequency component.

The band rejection filter can be expressed as Equation 8:

$$Band R ( u , v ) = 0 , if \sqrt{{u}^{2} + {v}^{2}} = j and arctan ( v / u ) = α \\ Band R ( u , v ) = 1 , else \qquad ( 8 )$$

wherein f denotes a screen frequency, and a denotes a screen angle.

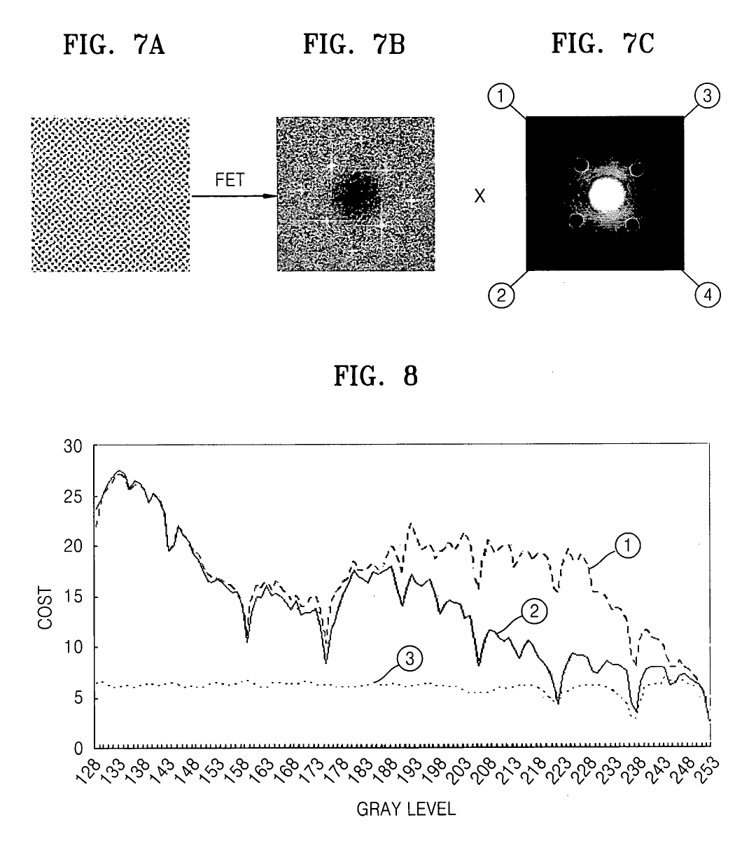

FIG. 7 illustrates images in which an evaluation function for a binary image is expressed. FIG. 7A illustrates a binary image, FIG. 7B illustrates a power spectrum of the binary image, and FIG. 7C illustrates an MTF×BandR. As illustrated in FIG. 7C, portions \textcircled{1}, \textcircled{2}, \textcircled{3}, and \textcircled{4} corresponding to a low-frequency component are removed by the band rejection filter.

FIG. 8 is a graph showing changes of evaluation functions for screens designed using a conventional screen designing method and using a screen designing method according to an exemplary embodiment of the present invention. The screens have identical frequencies (150.15 lpi), identical angles (39.47°), identical screen parameters A (14), identical screen parameters B (17), and identical TS (88).

In FIG. 8, \textcircled{1} and \textcircled{2} indicate changes in evaluation functions for screens designed according to conventional screen designing methods, and \textcircled{3} indicates a change in an evaluation function for a screen designed using a screen designing method according to an exemplary embodiment of the present invention. As illustrated in \textcircled{3} of FIG. 8, the evaluation function for the screen designed using a screen designing method according to an exemplary embodiment of the present invention is low.

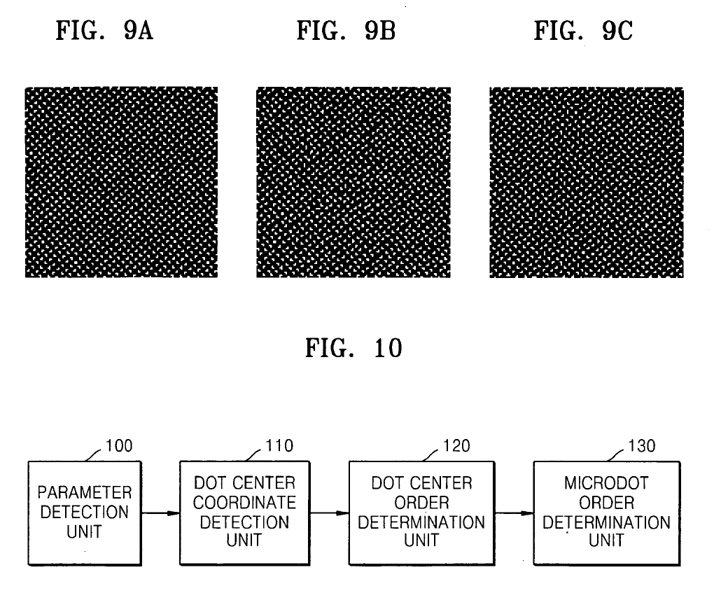

FIGS. 9A, 9B, and 9C illustrate images obtained by binarizing an image with a single gray level using the three screens of FIG. 8. FIG. 9A illustrates an image binarized using the screen corresponding to \textcircled{1} of FIG. 8, FIG. 9B illustrates an image binarized using the screen corresponding to \textcircled{2} of FIG. 8, and FIG. 9C illustrates an image binarized using the screen corresponding to \textcircled{3} of FIG. 8.

As illustrated in FIG. 9C, the degree of a moiré pattern having a low frequency component and the disorder of an image is reduced.

After operation 34, the frequency of calculations of the evaluation function is checked to determine whether the frequency exceeds a predetermined frequency in operation 36. If the frequency of calculations of the evaluation function does not exceed the predetermined frequency, the method is fed back to operation 32.

On the other hand, if the frequency of calculations of the evaluation function exceeds the predetermined frequency, a microdot order in which candidate dots with the smallest evaluation function among the calculated evaluation functions are turned on is determined, in operation 38.

If the frequency of calculations of an evaluation function is 4000, an evaluation function having a minimal value can be detected from 4000 evaluation functions. A microdot order in which candidate dots having the smallest evaluation function among the 4000 evaluation functions are turned on is determined.

The microdot order of the candidate dots with the smallest evaluation function is determined sequentially by a candidate dot farthest from a reference dot center as the microdot order.

After operation 38, a check is made in operation 40 to determine whether all of the microdots on the screen have been ordered. If all of the microdots on the screen are not ordered, the method is fed back to operation 30.

In operation 30 (performed again after operation 40), a new cluster radius is set and the subsequent operations are repeated. The new cluster diameter is set to be larger than the originally set cluster radius.

In operation 32 of a second phase of the method, candidate microdots to be turned on are selected from microdots other than the microdots that have already been ordered.

The embodiment of the screen designing method according to the exemplary embodiment of present invention can be written as computer codes/instructions/programs and can be implemented in general-use digital computers that execute the codes/instructions/programs using, for example, a computer readable recording medium. Examples of the computer readable recording medium include magnetic storage media (e.g., ROM, floppy disks, hard disks, and magnetic tapes, among others), optical recording media (e.g., CD-ROMs, or DVDs), and storage media such as carrier waves (e.g., transmission through the Internet). The computer readable recording medium can also be distributed over network coupled computer systems so that the computer readable code is stored and executed in a distributed fashion. Also, functional programs, codes, and code segments for accomplishing an exemplary embodiment of the present invention can be easily construed by programmers skilled in the art to which an exemplary embodiment of the present invention pertains.

FIG. 10 is a block diagram of a screen designing device that reduces a moiré pattern, according to an exemplary embodiment of the present invention. The screen designing device includes a parameter detection unit 100, a dot center coordinate detection unit 110, a dot center order determination unit 120, and a microdot order determination unit 130.

The parameter detection unit 100 detects screen parameters corresponding to a preset screen frequency, a preset screen angle, and a preset resolution. The parameter detection unit 100 outputs the screen parameters to the dot center coordinate detection unit 110. The parameter detection unit 100 detects the screen parameters using Equation 1.

The dot center coordinate detection unit 110 detects the coordinates of dot centers as the centers of cluster dots each with a plurality of microdots and outputs the dot center coordinates to the dot center order determination unit 120.

The dot center coordinate detection unit 110 detects the coordinates of the dot centers by using Equation 3.

The detected coordinates of the dot centers are real number coordinates.

The dot center order determination unit 120 determines a dot center order indicating a sequence in which the dot centers are turned on and outputs the dot center order to the microdot order determination unit 130.

A dot center farthest from a dot center as a reference is determined sequentially as the dot center order.

The microdot order determination unit 130 determines a microdot order indicating a sequence in which the microdots are turned on, using an evaluation function that quantitates the perception of a moiré pattern by the human's vision.

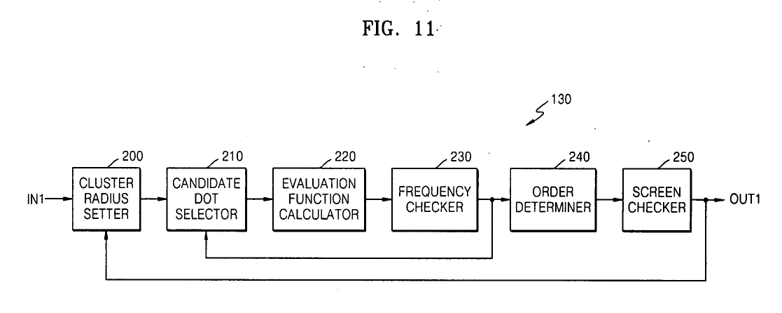

FIG. 11 is a block diagram of the microdot order determination unit 130 of FIG. 10. The microdot order determination unit 130 includes a cluster radius setter 200, a candidate dot selector 210, an evaluation function calculator 220, a frequency checker 230, an order determiner 240, and a screen checker 250.

The cluster radius setter 200 sets cluster radii extending from the dot centers using Equation 4 and outputs the cluster radii to the candidate dot selector 210.

The candidate dot selector 210 arbitrarily selects a predetermined number of candidate microdots to be turned on from the microdots existing within each of the set cluster radii, and outputs the selected candidate microdots to the evaluation function calculator 220. The candidate microdots are selected randomly.

The evaluation function calculator 220 calculates an evaluation function for the selected candidate microdots and outputs the evaluation function to the frequency checker 230. The evaluation function calculator 220 calculates the evaluation function using Equation 7. A band rejection filter is expressed in Equation 8.

The frequency checker 230 checks to determine whether the frequency of calculations of the evaluation function exceeds a predetermined frequency and outputs a result of the checking to the order determiner 240 and the candidate dot selector 210.

If the frequency of calculations of the evaluation function exceeds the predetermined frequency, the frequency checker 230 outputs the result of the checking to the order determiner 240. If the frequency of calculations of the evaluation function calculated does not exceed the predetermined frequency, the frequency checker 230 outputs the result of the checking to the candidate dot selector 210.

In response to the result of the checking, the order determiner 240 determines a microdot order in which candidate dots with the smallest evaluation function are turned on, and outputs the microdot order to the screen checker 250.

The microdot order of the candidate dots having the smallest evaluation function is determined sequentially by a candidate dot farthest from a reference dot center as the microdot order.

The screen checker 250 checks to determine whether all of the microdots on the screen are ordered. If all of the microdots on the screen are ordered, the screen checker 250 outputs a result of the checking via an output port OUT1. If all of the microdots on the screen are not ordered, the screen checker 250 outputs a result of the checking to the cluster radius setter 200.

In a screen designing method and a screen designing device for reducing a moiré pattern according to an exemplary embodiment of the present invention, a microdot order is determined using an evaluation function based on the visual characteristics of a human, thereby preventing patterns that degrade the quality of image formation and a moiré pattern from being generated.

While the present invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A screen designing method for reducing a moiré pattern, the method comprising:
detecting screen parameters corresponding to a reference screen frequency, a reference screen angle, and a reference resolution;
detecting the coordinates of dot centers as the centers of cluster dots each comprising a plurality of microdots;
determining a dot center order indicating a sequence in which the dot centers are turned on; and
determining a microdot order indicating a sequence in which the microdots are turned on, using an evaluation function that quantitates the perception of a moiré pattern by a human's vision.

2. The screen designing method of claim 1, wherein in the detecting of the dot center coordinates, real number coordinates of the dot centers are detected.

3. The screen designing method of claim 1, wherein in the determining of the dot center order, a dot center farthest from a dot center as a reference is determined sequentially as the dot center order.

4. The screen designing method of claim 1, wherein the determining of the microdot order comprises:
setting cluster radii extending from the dot centers;
arbitrarily selecting a number of candidate microdots to be turned on from the microdots existing within each of the set cluster radii;
calculating an evaluation function for the selected candidate microdots;
checking the frequency of calculations of the evaluation function to determine whether the frequency exceeds a frequency;
determining a microdot order in which candidate dots comprising the smallest evaluation function among the calculated evaluation functions are turned on, if the frequency of calculations of the evaluation function exceeds the frequency; and
checking all of the microdots on the screen to determine whether the microdots are ordered,
wherein:
if the frequency of calculations of the evaluation function does not exceed the frequency, the method returns to the step of arbitrarily selecting of the number of candidate microdots;
if all of the microdots on the screen are ordered, the method ends; and
if all of the microdots on the screen are not ordered, the method returns to the step of setting of the cluster radii.

5. The screen designing method of claim 4, wherein in the setting of the cluster radii, the cluster radii are set using the following equation:
CR=k\sqrt{n/π}
wherein CR denotes a cluster radius, k denotes a constant, n denotes the number of microdots, and π denotes the ratio of the circumference of a circle to its diameter.

6. The screen designing method of claim 4, wherein in the calculating of the evaluation function, the evaluation function is calculated using the following equation:
$$EF = {\sum }_{u}^{N} {\sum }_{v}^{N} {MTF ( u , v )}^{2} ( X ( u , v ) \times {X}^{*} ( u , v ) ) BandR ( u , v )$$
wherein EF denotes the evaluation function, MTF denotes a modulation transfer function for representing the visual characteristics of a human as a frequency domain, X(u, v) denotes a complex number value of an image in a frequency domain, X*(u, v) denotes a conjugate complex number of X(u, v), and BandR(u, v) denotes a band rejection filter for removing a screen frequency component.

7. The screen designing method of claim 6, wherein in the calculating of the evaluation function, the band rejection filter is expressed as the following equation:
$$Band R ( u , v ) = 0 , if \sqrt{{u}^{2} + {v}^{2}} = j and arctan ( v / u ) = α$$
$$Band R ( u , v ) = 1 , else$$
wherein f denotes a screen frequency, and α denotes a screen angle.

8. The screen designing method of claim 4, wherein in the determining of the microdot order in which the candidate dots comprising the smallest evaluation function are turned on, a candidate dot farthest from a dot center as a reference is determined sequentially as the microdot order.

9. A computer-readable recording medium which records a program for executing the method of claim 1.

10. A screen designing device comprising:
a parameter detection unit for detecting screen parameters corresponding to a reference screen frequency, a reference screen angle, and a reference resolution;
a dot center coordinate detection unit for detecting the coordinates of dot centers being the centers of cluster dots each comprising a plurality of microdots;
a dot center order determination unit for determining a dot center order indicating a sequence in which the dot centers are turned on; and
a microdot order determination unit for determining a microdot order indicating a sequence in which the microdots are turned on, using an evaluation function that quantitates the perception of a moiré pattern by a human's vision.

11. The screen designing device of claim 10, wherein the coordinates of the dot centers detected by the dot center coordinate detection unit are real number coordinates.

12. The screen designing device of claim 10, wherein a dot center farthest from a dot center as a reference is determined sequentially as the dot center order.

13. The screen designing device of claim 10, wherein the microdot order determination unit comprises:
a cluster radius setter for setting cluster radii extending from the dot centers;
a candidate microdot selector for arbitrarily selecting a number of candidate microdots to be turned on from the microdots existing within each of the set cluster radii;
an evaluation function calculator for calculating an evaluation function for the selected candidate microdots;
a frequency checker for checking if the frequency of calculations of the evaluation function exceeds a frequency;
an order determiner for determining a microdot order in which candidate dots comprising the smallest evaluation function among the calculated evaluation functions are turned on, if the frequency of calculations of the evaluation function exceeds the frequency; and
a screen checker for checking whether all of the microdots on the screen are ordered.

14. The screen designing device of claim 13, wherein in the cluster radius setter sets the cluster radii using the following equation:
CR=k\sqrt{n/π}
wherein CR denotes a cluster radius, k denotes a constant, n denotes the number of microdots, and π denotes the ratio of the circumference of a circle to its diameter.

15. The screen designing device of claim 13, wherein the evaluation function calculator calculates the evaluation function using the following equation:
$$EF = {\sum }_{u}^{N} {\sum }_{v}^{N} {MTF ( u , v )}^{2} ( X ( u , v ) \times {X}^{*} ( u , v ) ) BandR ( u , v )$$
wherein EF denotes the evaluation function, MTF denotes a modulation transfer function for representing the visual characteristics of a human as a frequency domain, X(u, v) denotes a complex number value of an image in a frequency domain, X*(u, v) denotes a conjugate complex number of X(u, v), and BandR(u, v) denotes a band rejection filter for removing a screen frequency component.

16. The screen designing device of claim 15, wherein the band rejection filter is expressed as the following equation:
$$Band R ( u , v ) = 0 , if \sqrt{{u}^{2} + {v}^{2}} = j and arctan ( v / u ) = α$$
$$Band R ( u , v ) = 1 , else$$
wherein f denotes a screen frequency, and a denotes a screen angle.

17. The screen designing device of claim 13, wherein the order determiner determines sequentially a candidate dot farthest from a reference dot center as the microdot order.
